(19) United States
(12) Patent Application Publication
(10) Pub. No.: US 2009/0037601 A1
(43) Pub. Date: Feb. 5, 2009

(54) System and Method for Updating State Information in a Router

(75) Inventors: Amit Jain, Santa Clara, CA (US); Steven Lin, Cupertino, CA (US); Sriram Raghunathan, Cupertino, CA (US); Sandeep Jain, Santa Clara, CA (US)

Correspondence Address: AKIN GUMP STRAUSS HAUER & FELD LLP, P.O.BOX 688, DALLAS, TX, 75313-0688, US

(73) Assignee: Juniper Networks, Inc.

(21) Appl. No.: 11/833,696

(22) Filed: Aug. 3, 2007

(51) Int. Cl. G06F 15/173

(52) U.S. Cl. 709/242

(57) ABSTRACT

Systems and methods consistent with the present invention enable routing table updates are performed by optimally utilizing the resources of a node without exceeding the resources of the node. Using feedback on the amount of resources available to the nodes, such as in terms of available memory, the node may make new connections before breaking old one where those updates will not exceed available resources. This is referred to as make-before-break. When not enough resources are available, the node will break old connections before making new ones. This is referred to as break-before-make. Unlike the strict make-before-break and break-before-make models, this “loose” make-before-break method considers the amount of available resources in view of the resources required to perform the routing table updates without a node failure. Routes may also be tagged to prioritize the addition of more important routes and the deletion of less significant routes. Methods and systems consistent with the present invention, therefore, provide a routing table update method with which routing table updates are achieved without crashing and at the same time minimizing black hole intervals.

### FIELD OF THE INVENTION

The present invention generally relates to a network router, and relates more particularly to dynamically updating routing tables.

### BACKGROUND

In computer networking, the term “routing” refers to selecting paths in a computer network along which to send data. Routing directs the passing of logically addressed packets from their source network toward their ultimate destination through intermediary nodes, typically hardware devices called routers. The routing process usually directs forwarding on the basis of routing tables which maintain a record of the best routes to various network destinations. Thus constructing routing tables, which are held in the routers' memory, becomes important for efficient routing.

Small networks may involve manually configured routing tables, while larger networks involve complex topologies and may change constantly, making the manual construction of routing tables problematic. Dynamic routing attempts to solve this problem by constructing routing tables automatically, based on information carried by routing protocols, and allowing the network to act nearly autonomously in avoiding network failures and blockages.

In performing link-state routing, each node uses as its fundamental data a map of the network in the form of a graph. To produce this, each node floods the entire network with information about what other nodes it can connect to, and each node then independently assembles this information into a map. Using this map, each router then independently determines the best route from itself to every other node.

First, each node needs to determine what other ports it is connected to, over fully-working links; it does this using a simple reachability protocol which it runs separately with each of its directly-connected neighbors. Next, each node periodically makes up a short message, the link-state advertisement, which identifies the node which is producing it, identifies all the other nodes to which it is directly connected, and includes a sequence number that increases every time the source node makes up a new version of the message. This message is then flooded throughout the network. As a precursor, each node in the network remembers, for every other node in the network, the sequence number of the last link-state message which it received from that node. With that in hand, the method used is simple. Starting with the node which originally produced the message, it sends a copy to all of its neighbors. When a link-state advertisement is received at a node, the node looks up the sequence number it has stored for the source of that link-state message. If this message is newer (i.e., has a higher sequence number), it is saved, and a copy is sent in turn to each of that node's neighbors. This procedure rapidly distributes a copy of the latest version of each node's link-state advertisement to every node in the network.

Finally, with the complete set of link-state advertisements (one from each node in the network) in hand, a node can produce the graph for the map of the network. The process simply iterates over the collection of link-state advertisements; for each one, it makes links on the map of the network, from the node which sent that message, to all the nodes which that message indicates are neighbors of the sending node. No link is considered to have been correctly reported unless the two ends agree; i.e., if one node reports that it is connected to another, but the other node does not report that it is connected to the first, there is a problem, and the link is not included on the map.

Each node independently runs an algorithm over the map to determine the shortest path from itself to every other node in the network. This procedure produces a tree containing all the nodes in the network, with the node on which the algorithm is running as the root of the tree. The shortest path from that node to any other node is indicated by the list of nodes one traverses to get from the root of the tree, to the desired node in the tree. For any given destination node, the best next hop for that destination is the node which is the first step from the root node, down the branch in the shortest-path tree which leads toward the desired destination node. The routing table is created by walking the tree, remembering the identity of the node at the head of each branch, and filling in the routing table entry, or link state, for each node with that identity.

When the network topology changes, such as when a link between two nodes fails, the routing table entries in the routing table must be updated. This update may result in a flood of link state advertisements entering a node, which consume memory and processing resources in that node. Conventionally, there are three methods of handling routing table updates. In the first method, the routing table information in the routing table is changed to reflect the new route. However, this method requires additional time to reprogram the routing table. In the second method, a faster link state update is achieved by simply adding the new routing table entry in the routing table and then deleting the old routing table entry. However, this method, referred to as the “make-before-break model,” consumes a large amount of memory when a large number of routing table entries have to be added before the old entries are deleted. In the third method, the routing table entries are deleted before new routing table entries are added. However, this method, referred to as the “break-before-make model,” produces the risk of creating a black hole condition. That is, a packet may be received during the time between deletion of the old routing table entry and the addition of the new routing table entry, and thus there is no next hop information for that packet. It is therefore desirable to provide an improved routing table update mechanism.

### SUMMARY

Methods and systems consistent with the present invention provide a routing table update method that is typically more efficient than conventional methods. For example, routing table updates are achieved without crashing the system and black hole conditions are minimized. A “loose” make-before-break method consistent with the present invention performs routing table updates using the make-before-break method as often as possible without exceeding the resources of the node. With feedback on the amount of resources available to the nodes, such as in terms of available memory, the node may perform make-before-break updates where those updates will not exceed available resources, and break-before-make updates when those updates will exceed available resources. Unlike the strict make-before-break and break-before-make models, the “loose” make-before-break method considers the amount of available resources in view of the resources required to perform the routing table updates without a node failure.

One embodiment consistent with the present invention is directed to a method in a data processing system for dynamically updating routing table information. The data processing system includes a router connected to a network and has a memory storing a routing table including routing table entries for links to the network. The method includes receiving routing table update information, determining whether there are available resources in the router, performing a routing table update in accordance with a first update method when the router is determined to have available resources, and performing a routing table update in accordance with a second update method when the router is determined to have no available resources. The first update method includes adding a new entry for the link to the routing table before deleting an old entry for the link from the routing table. The second update method includes deleting an old entry for the link from the routing table before adding a new entry for the link to the routing table. Adding a new entry includes deriving the new entry from the routing table update information

In one embodiment consistent with the present invention, receiving routing table update information includes receiving routing table update information from another router in the network, and determining whether there are available resources in the router includes determining an amount of available memory. There are resources available when the amount of available entry can store at least one routing table entry, while there are no resources available when the amount of available entry cannot store at least one routing table entry. Determining whether there are available resources in the router may also include determining CPU usage.

Another embodiment consistent with the present invention is directed to a computer-readable medium storing computer executable instructions for performing a method of dynamically updating routing table information in a router connected to a network and having a memory storing a routing table including routing table entries for links to the network. The method comprises ranking entries in the routing table based on link importance, receiving routing table update information, determining the rank of the link, determining whether there are available resources in the router, performing a routing table update in accordance with a first update method when the router is determined to have available resources, and performing a routing table update in accordance with a second update method when the router is determined to have no available resources. The first update method includes adding a new entry for the link to the routing table before deleting an old entry for the link from the routing table. The second update method includes a new entry for the link to the routing table before adding another entry for another link of lesser importance. Adding a new entry includes deriving the new entry from the routing table update information.

In yet another embodiment consistent with the present invention, ranking entries in the routing table based on link importance includes ranking entries based on a desired quality of service level for the link, and determining whether there are available resources in the router includes determining an amount of available memory. There are resources available when the amount of available entry can store at least one routing table entry, while there are no resources available when the amount of available entry cannot store at least one routing table entry.

Yet another embodiment consistent with the present invention is directed to a data processing system for dynamically updating routing table information. The data processing system comprises a memory storing a routing table including routing table entries for links to the network, and a computer program that receives routing table update information, matches the routing table update information to a link in the network, determines whether there are available resources in the router, performs a routing table update in accordance with a first update method when the router is determined to have available resources, wherein the first update method includes adding a new entry for the link to the routing table before deleting an old entry for the link from the routing table, and performs a routing table update in accordance with a second update method when the router is determined to have no available resources, wherein the second update method includes deleting an old entry for the link from the routing table before adding a new entry for the link to the routing table, and a processor executing the computer program.

Other systems, methods, features, and advantages consistent with the present invention will become apparent to one with skill in the art upon examination of the following figures and detailed description. It is intended that such additional systems, methods, features, and advantages be included within this description and be within the scope of the invention.

### BRIEF DESCRIPTION OF THE DRAWINGS

The accompanying drawings, which are incorporated in and constitute a part of this specification, illustrate an implementation of methods and systems consistent with the present invention and, together with the description, serve to explain advantages and principles consistent with the invention. In the drawings,

FIG. 1 illustrates an exemplary network environment suitable for use with systems and methods consistent with the present invention;

FIG. 2 illustrates an exemplary router suitable for use with systems and methods consistent with the present invention;

FIG. 3 illustrates a method for updating a router consistent with methods and systems consistent with the present invention; and

FIG. 4 illustrates another method for updating a router consistent with methods and systems consistent with the present invention.

### DETAILED DESCRIPTION

Methods and systems consistent with the present invention dynamically update routing tables in a node, e.g., a router in a network, in a reliable and efficient manner. For example, methods and systems consistent with the present invention update routing tables in such a way to reduce the occurrence of black holes and crashes.

Consider an example where a node maintains a routing table with routing table entries consume 90% of the node's memory. Suppose a link failure requires that all of those routing table entries must be updated. In the make-before-break model, memory usage would go from 90% to 180% to 90%. Thus, there is a time where the node does not have enough resources to maintain the routing table, leading to a system failure. In the break-before-make model, memory usage would go from 90% to 0% to 90%. While the node's resources are not over-extended, there is a time where no routing information exists for incoming packets and thus routing cannot occur, a condition known as a “black hole.” Methods and systems consistent with the present invention provide a routing table update scheme where updates are performed within the bounds of the node's resources while maintaining routing information for each route at all times.

In accordance with methods and systems consistent with the present invention, the router determines that its routing table requires an update, e.g., by receiving a link state advertisement or determining that a link has failed. The router then determines whether there are available resources, e.g., memory, to handle the update, which requires adding entries to the routing table. The router performs the routing table update using the make-before-break model when the router is determined to have available resources sufficient for the update. The router performs the routing table update using the break-before-make method when the router is determined to have insufficient resources for the update. Thus, crashes are avoided and black holes are reduced.

Reference will now be made in detail to an implementation consistent with the present invention as illustrated in the accompanying drawings.

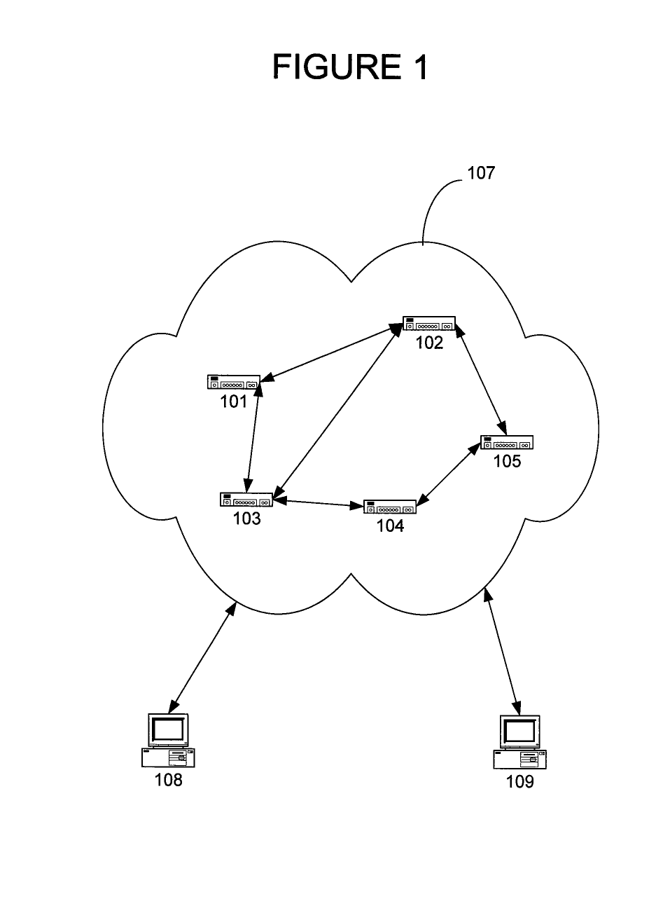

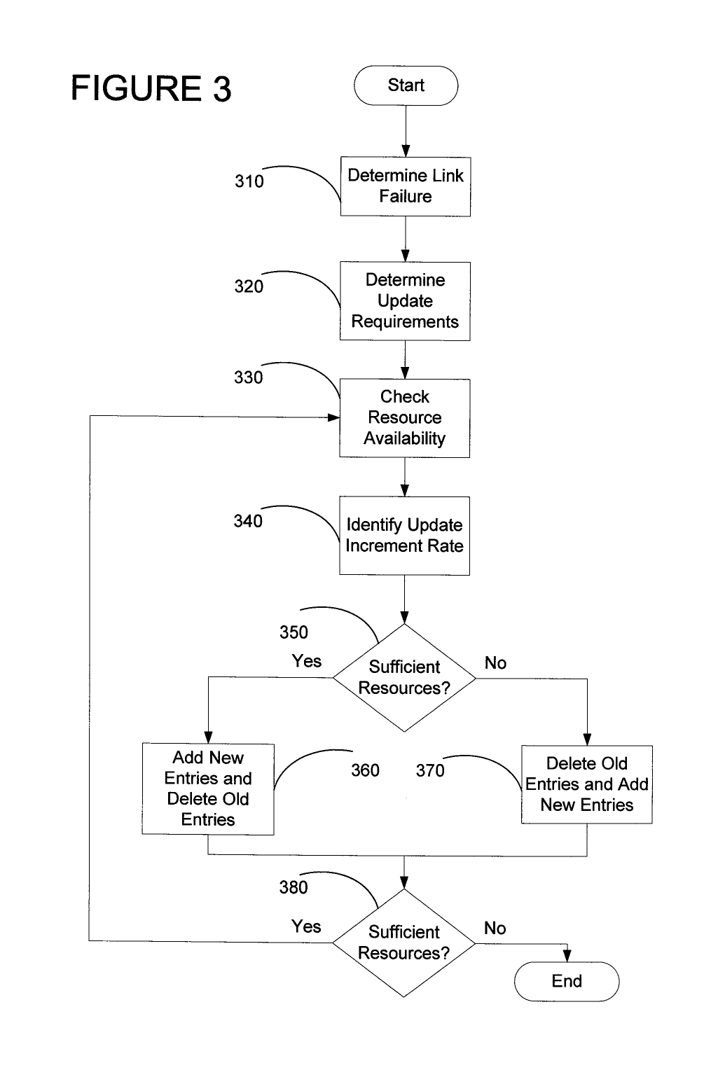

FIG. 1 illustrates a network in which methods and systems consistent with the present invention may be implemented. Routers 101, 102, 103, 104, and 105 are part of network 107 connecting, for example, computers 108 and 109. Routers 101, 102, 103, 104, and 105 may be directly connected to each other. However, in the example illustrated in FIG. 1, the network topology is such that router 101 routes packets to routers 102 and 103; router 102 routes packets to routers 101, 103, and 105; router 103 routes packets to routers 101, 102, and 104; router 104 routes packets to routers 103 and 105; and router 105 routes packets to routers 102 and 104. Thus, when computer 108 sends packetized data to computer 109, the packets may be routed from router 101 to router 102 to router 105, depending on the routing tables (described below) maintained by each router. When those routing tables require updating, they are updated in accordance with a routing table update method, as illustrated, for example, in FIG. 3.

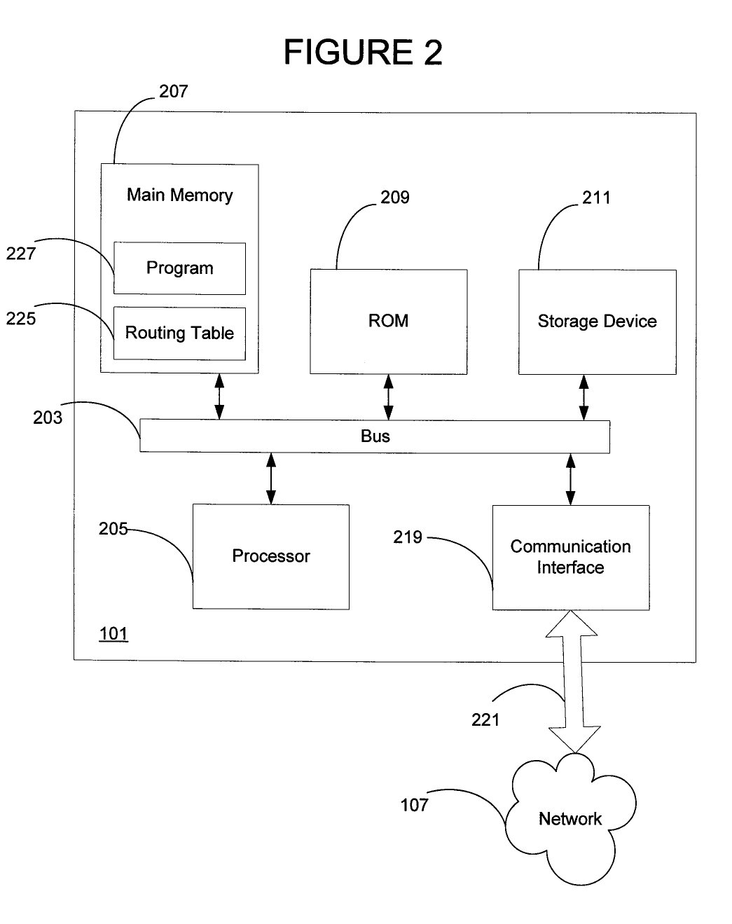

Turning to FIG. 2, an exemplary router consistent with methods and systems consistent with the present invention is now described. A router, for example router 101, includes a bus 203 or other communication mechanism for communicating information, and a processor 205 coupled with bus 203 for processing the information. Router 101 also includes a main memory 207, such as a random access memory (RAM) or other dynamic storage device, coupled to bus 203 for storing information and instructions to be executed by processor 205. In addition, main memory 207 may be used for storing temporary variables or other intermediate information during execution of instructions to be executed by processor 205. Main memory 207 includes a program 227 for implementing routing table update methods consistent with the invention and described below, and routing table 225, also described below. Router 101 further includes a read only memory (ROM) 209 or other static storage device coupled to bus 203 for storing static information and instructions for processor 205. A storage device 211, such as a magnetic disk or optical disk, is provided and coupled to bus 203 for storing information and instructions.

According to one embodiment, processor 205 executes one or more sequences of one or more instructions contained in main memory 207. Such instructions may be read into main memory 207 from another computer-readable medium, such as storage device 211. Execution of the sequences of instructions in main memory 207 causes processor 205 to perform the process steps described herein. One or more processors in a multi-processing arrangement may also be employed to execute the sequences of instructions contained in main memory 207. In alternative embodiments, hard-wired circuitry may be used in place of or in combination with software instructions. Thus, embodiments are not limited to any specific combination of hardware circuitry and software.

Although described relative to main memory 207 and storage device 211, instructions and other aspects of methods and systems consistent with the present invention may reside on a computer-readable medium, such as a floppy disk, a flexible disk, hard disk, magnetic tape, a CD-ROM, magnetic, optical or physical medium, a RAM, a PROM, and EPROM, a FLASH-EPROM, any other memory chip or cartridge, or any other medium from which a computer can read, either now known or later discovered.

Router 101 also includes a communication interface 219 coupled to bus 203. Communication interface 219 provides a two-way data communication coupling to a network link 221 that is connected to a network 107. Wireless links may also be implemented. In any such implementation, communication interface 219 sends and receives signals that carry digital data streams representing various types of information.

Routing table 225 is now described. Routing protocols use metrics to evaluate what path will be the best for a packet to travel. A metric is a standard of measurement, such as path bandwidth, that is used by routing algorithms to determine the optimal path to a destination. To aid the process of path determination, routing algorithms initialize and maintain routing tables, such as routing table 225, which contain route information. Route information varies depending on the routing algorithm used.

Routing algorithms fill routing tables with a variety of information. Destination/next hop associations tell a router that a particular destination can be reached optimally by sending the packet to a particular router representing the “next hop” on the way to the final destination. When a router receives an incoming packet, it checks the destination address and attempts to associate this address with a next hop. Table 1 illustrates an exemplary routing table 225.

TABLE 1

| Destination IP Address | Next Hop IP Address |
|---|---|
| 123.456.789.123 | 234.567.890.123 |
| 212.234.567.789 | 204.234.567.890 |
| 232.123.345.678 | 242.265.765.456 |

Routing tables also can contain other information, such as data about the desirability of a path. Routers compare metrics to determine optimal routes, and these metrics differ depending on the design of the routing algorithm used. Routing tables may also include information about the path such as a security protocol of the “next hop.” In an embodiment consistent with the invention, the routing table 225 is maintained in a database.

FIG. 3 illustrates a method of updating routing table entries consistent with the present invention. The router 101 will determine that there is a link failure that affects the router's routing table, either by discovering a non-responsive next hop router or by receiving a link state advertisement from another router in a network 107 (step 310). This link state advertisement could include information about the state of one or more paths or links in the network 107. The router determines from the link failure how many routing table entries are affected and what resources, such as memory resources, are needed to perform the routing table updates (step 320). The router may need to update anywhere between 1 and all of the entries in the routing table 225. Because the routing table is maintained in memory 207 and there is a finite amount of memory, it is desirable to avoid exceeding the router's memory resources, as doing so may cause the router to crash.

Thus, the router first checks the available resources in the router (step 330). The router then identifies an update increment, which is the number of updates the router will perform before determining the available resources again (step 340). The update increment may be preconfigured, or may by dynamically calculated based on the amount of available resources. For example, the update increment may be equivalent to the number of entries that will fit in the available memory. For purposes of explanation, assume the update increment has the value N. If the router determines that there are sufficient resources to make N updates (step 350), then the router adds N new routing table entries based on the received link state advertisement before deleting the old entries pertaining to those same links (step 360). Sufficient resources would be, for example, enough memory to add N more entries to the routing table. If the router determines that there are insufficient resources to make N updates (step 350), then the router deletes N old routing table entries relating to the link before adding N new entries pertaining to those links based on the received link state advertisement (step 370). The router then determines whether there are more entries to update (step 380). If there are more entries, the router performs another iteration of updating beginning with step 330. Otherwise, the router has finished updating the routing table. Accordingly, when there are resources available, the routing table updates are made without inducing a black hole condition where packets are lost. However, when there are no resources available, the potential black hole condition is preferred over crashing the routing.

For example, consider a router with a routing table 225 that contains 75 entries and can hold a maximum of 100 entries. In this example, assume the increment size is 10 entries, and that 20 entries need to be updated. The router would determine the available resources (room for 25 entries) and the update increment (10 entries), and would add 10 new entries to the routing table. The router, now at 85 entries, would then delete 10 old entries corresponding to the 10 old entries. The router would then determine that there are still 10 updates remaining, and would make those updates in a similar fashion.

Now assume that the same exemplary routing table 225 contains 95 entries with the same capacity and increment rate. The router would determine that it has insufficient available resources (room for 5 entries) to add 10 new entries in accordance with the increment rate. Thus, the router would delete 10 entries before adding 10 new updated entries corresponding to the 10 deleted entries.

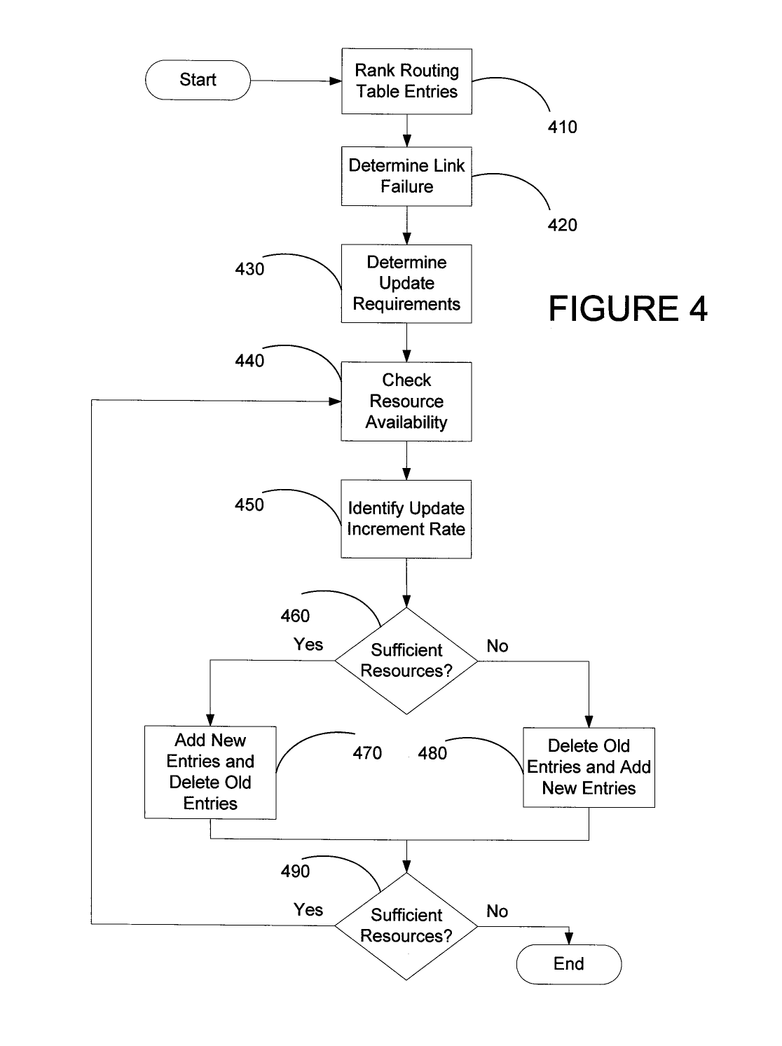

FIG. 4 illustrates another method of updating routing table entries consistent with the present invention. In this embodiment, the routing table entries are given a rank of importance (step 410). For example, there may be a link that is more vital to the network 107 than others, and thus greater effort should be taken to maintain that link. Such rankings may be based on static parameters, such as which customer the link affects or a desired quality of service level or an importance level for a given path. These rankings may also be based on dynamic parameters, such as high traffic usage. These routing table updates are given priority over other routing table updates. A router will determine that there is a link failure that affects the router's routing table 225, either by a non-responsive router or by receiving a link state advertisement from another router in a network (step 420). The router determines from the link failure how many routing table entries are affected and what resources, such as memory resources, are needed to perform the routing table updates (step 430). The router may need to update anywhere between 1 and all of the entries in the routing table. Thus, the router first checks the available resources in the router (step 440).

The router then identifies an update increment, which is the number of updates the router will perform before determining the available resources again (step 450). As previously explained, the update increment may be preconfigured, or may by dynamically calculated based on the amount of available resources. For purposes of explanation, assume the update increment has the value N. If the router determines that there are sufficient resources to make N updates (step 460), then the router adds N new routing table entries based on the received link state advertisement before deleting the old entries pertaining to those same links (step 470). The N highest-ranked entries are updated first. Sufficient resources would be, for example, enough memory to add N more entries to the routing table. If the router determines that there are insufficient resources to make N updates (step 460), then the router deletes N old routing table entries relating to the link before adding N new entries pertaining to those links based on the received link state advertisement (step 480). Again, the N highest-ranked resources are updated first. The router then determines whether there are more entries to update (step 490). If there are more entries, the router performs another iteration of updating beginning with step 440. Otherwise, the router has finished updating the routing table. Accordingly, when there are resources available, the routing table updates are made without inducing a black hole condition where packets are lost. However, when there are no resources available, the potential black hole condition is preferred over crashing the routing.

While there has been illustrated and described embodiments consistent with the present invention, it will be understood by those skilled in the art that various changes and modifications may be made and equivalents may be substituted for elements thereof without departing from the true scope of the invention. Therefore, it is intended that this invention not be limited to any particular embodiment disclosed, but that the invention will include all embodiments falling within the scope of the appended claims.

We claim:

1. A method in a data processing system for dynamically updating routing table information, the data processing system including a router connected to a network and having a memory storing a routing table including routing table entries for links in the network, the method comprising the steps of:
determining that the routing table requires an update;
determining whether the router has available resources;
performing a routing table update in accordance with a first update method when the router is determined to have available resources sufficient for the update, wherein the first update method includes adding a new entry for one of the links in the network before deleting an old entry for the one link in the network; and
performing a routing table update in accordance with a second update method that is different from the first update method when the router is determined to have insufficient resources for the update, wherein the second update method includes deleting the old entry for the one link from the routing table before adding the new entry to the routing table for the one link.

2. The method of claim 1, further comprising determining an increment rate indicating the number of entries that are added or deleted.

3. The method of claim 2, wherein determining an increment rate includes determining the increment rate based on the available resources.

4. The method of claim 1, wherein determining an increment rate includes determining the increment rate based on a preconfigured increment rate.

5. The method of claim 1, wherein the new entry is based on information received from another router in the network.

6. The method of claim 1, wherein determining whether there are available resources in the router includes determining an amount of available memory.

7. The method of claim 6, further comprising determining that there are available resources when the determined amount of available memory is sufficient to store at least the number of routing table entries equal to the increment rate.

8. The method of claim 6, further comprising determining that there are insufficient resources when the determined amount of available memory is insufficient to store at least the number of routing table entries equal to the increment rate.

9. The method of claim 1, wherein the first update method is a make-before-break method.

10. The method of claim 1, wherein the second update method is a break-before-make method.

11. A computer-readable medium storing computer executable instructions for performing a method of dynamically updating routing table information in a router connected to a network and having a memory storing a routing table including routing table entries for links in the network, the method comprising the steps of:
ranking entries in the routing table;
determining that the routing table requires an update;
determining whether the router has sufficient available resources to perform the update;
performing a routing table update in accordance with a first update method when the router is determined to have available resources sufficient for the update, wherein entries are updated in order of rank, and wherein the first update method includes adding a new entry for the link in the routing table before deleting an old entry for the link from the routing table; and
performing a routing table update in accordance with a second update method when the router is determined to have insufficient resources for the update, wherein entries are updated in order of rank, and wherein the second update method includes deleting the old entry for the link from the routing table before adding the new entry for the link to the routing table.

12. The method of claim 11, further comprising determining an increment rate indicating the number of entries that are added or deleted.

13. The method of claim 12, wherein determining an increment rate includes determining the increment rate based the available resources.

14. The method of claim 11, wherein determining an increment rate includes determining the increment rate based on a preconfigured increment rate.

15. The method of claim 14, wherein the new entry is based on information received from another router.

16. The method of claim 11, wherein ranking entries in the routing table includes ranking entries based on a desired quality of service level for the link.

17. The method of claim 11, wherein determining whether there are available resources in the router includes determining an amount of available memory.

18. The method of claim 17, further comprising determining that there are available resources when a memory can store at least the number of routing table entries equal to the increment rate.

19. The method of claim 17, further comprising determining that there are insufficient resources when a memory cannot store at least the number of routing table entries equal to the increment rate.

20. A data processing system including a router for dynamically updating routing table information, the router connected to a network and comprising:
a memory comprising:
a routing table including routing table entries for associated links in the network; and
a computer program that determines the number of routing table entries to be updated, determines the amount of resources available to the router, updates an old routing table entry by creating a new routing table entry for the associated link before deleting the old routing table entry for the link while the amount of available resources is sufficient, and updates the old routing table entry by deleting the old routing table entry for the link before creating the new routing table entry for the link when the amount of available resources is insufficient; and
a processor for executing the computer program.
